(19) United States
(12) Patent Application Publication
(10) Pub. No.: US 2007/0151464 A1
(43) Pub. Date: Jul. 5, 2007

(54) FRYER FOR PASTA AND POTATOES

(75) Inventor: Tahsin OZTIRYAKI, Istanbul (TR)

Correspondence Address: EGBERT LAW OFFICES, 412 MAIN STREET, 7TH FLOOR, HOUSTON, TX, 77002, US

(73) Assignee: OZTIRYAKILER MADENI ESYA SANAYI VE TICARET ANONIM SIRKETI, Istanbul (TR)

(21) Appl. No.: 11/617,605

(22) Filed: Dec. 28, 2006

Related U.S. Application Data
(63) Continuation-in-part of application No. 11/095,861, filed on Mar. 31, 2005, now abandoned.

(30) Foreign Application Priority Data
Jan. 7, 2005 (TR) U2005/00074

(51) Int. Cl. F23D 14/14; F23D 14/62; A47J 27/026; A47J 37/12

(52) U.S. Cl. 99/403; 431/329; 431/354; 126/391.1

(57) ABSTRACT

A frying apparatus has a reservoir, a plurality of pipes in heat exchange relationship with the reservoir, and a burner connected to the plurality of pipes. The burner passes a heated gas to the plurality of pipes. The burner has a venturi passageway extending at a 45° angle with respect to a vertical axis of the reservoir. A flame directing surface is positioned interior of the plurality of pipes.

### CROSS-REFERENCE TO RELATED U.S. APPLICATIONS

The present application is a continuation-in-part of U.S. application Ser. No. 11/095,861, filed on Mar. 31, 2005, and entitled “Fryer for Pasta and Potatoes”, presently pending.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to fryers for use in cooking large amounts of ingredients in industrial kitchens. More particularly, the present invention relates to fryers that serve to reduce the cooking time by transferring a high heat to a cooking pool as fast as possible. More particularly, the present invention relates to a frying apparatus that includes cooking reservoirs, heater pipes, burners and a burner connection sheet.

2. Description of Related Art Including Information Disclosed Under 37 CFR 1.97 and 37 CFR 1.98.

Fryers are often used for cooking various foods such as pasta and potatoes. In the past, these fryers have included heating elements which are connected to the reservoir of the fryer so as to cause the cooking pool to achieve an elevated temperature. Once the cooking pool is elevated to a proper temperature, then various foods can be placed into the reservoir so as to effectively cook the food. Various types of mechanisms have been employed in the past for the purpose of elevating the temperature of the cooking pool. Typically, the cooking pool will have a cooking oil therein.

U.S. Pat. No. 6,101,929, issued on Aug. 15, 2000 to R. Saito, describes a fryer that slows the oxidation of an oil layer caused by fry sediment and carbide and generation of oil smoke, preventing deterioration of the oil layer. This fryer comprises a fry vessel containing water and oil therein. An oil layer is formed on a water layer by a difference therebetween in density. Heating pipes are formed in the fry vessel for heating the oil layer. Cooling pipes are formed at the lower portion of the heating pipes in the fry vessel for cooling a portion of the oil layer formed at the lower portion of each heating pipe. A water level detector is provided for detecting the arrival of a boundary surface between the oil layer and the water to a predetermined position of the lower portion of each heating pipe. An oil layer heating controller is connected to the water level detector for stopping the heating of the oil layer due to the heating pipes by the detection of the boundary surface.

It is an object of the present invention to provide a frying apparatus that serves to shorten the cooking time for large volumes of ingredients.

It is another object of the present invention to provide a frying apparatus which transfers heat to a cooking pool in a short period of time.

It is still a further object of the present invention to provide a frying apparatus that can be easily cleaned.

It is still another object of the present invention to provide a frying apparatus which minimizes the amount of bacteria in any waste foods.

These and other objects and advantages of the present invention will become apparent from a reading of the attached specification and appended claims.

### BRIEF SUMMARY OF THE INVENTION

The present invention is a frying apparatus that comprises a reservoir, a plurality of pipes in heat exchange relationship with the reservoir, and a burner means connected to the plurality of pipes. The burner means serves to pass a heated gas to the plurality of pipes. The burner means includes a venturi passageway connected to the pipe and extending at a 45 degree angle with respect to a vertical axis of the reservoir.

A sheet block is interposed between the burner means and at least one of the plurality of pipes. The sheet block has a serrated surface extending thereacross. The venturi passageway has a connector end at one end and a sheet block affixed over the opposite end thereof. The opposite end of the venturi passageway has a horizontal section. The sheet block is fitted over the horizontal section. The burner means comprises a plurality of venturi passageways each connected respectively to the plurality of pipes.

The plurality of pipes extend across an interior of the reservoir. The plurality of pipes are in sealed relationship with opposite walls of the reservoir. Each of the plurality of pipes has an elliptical shape such that a wide of surface of the plurality of pipes extends generally vertically.

A flame directing means is positioned interior of the plurality of pipes. The flame directing means serves to direct the heated gas in a desired pattern through the plurality of pipes. The flame directing means comprises a perforated sheet extending through the interior of each of the plurality of pipes. The perforated sheet has a convoluted shape. The perforated sheet also has rectangular channels formed therein.

In the present invention, a chimney is affixed to an opposite end of the plurality of pipes from the burner means. The chimney opens at a top of the reservoir so as to direct the heated gases vertically outwardly from the plurality of pipes. The reservoir includes a monolithic body having a cooking pool formed on the interior thereof and an upper table affixed to a top of the monolithic body.

### BRIEF DESCRIPTION OF THE SEVERAL VIEWS OF THE DRAWINGS

FIG. 1 is a partial cross-section side elevational view of the frying apparatus of the present invention.

FIG. 2 is a perspective end view showing of the frying apparatus of the present invention.

FIG. 3 is an exploded view of the fryer apparatus of the present invention.

FIG. 4 is an upper perspective exploded view of the reservoir of the frying apparatus of the present invention.

FIG. 5 is an exploded view of a burner as used in the frying apparatus of the present invention.

FIG. 6 is a cross-sectional view of the serrated surface of the sheet block as used on the burner of the present invention.

FIG. 7 is a perspective view of a heating pipe as used in the frying apparatus of the present invention.

FIG. 8 is an end of the heating pipe of the frying apparatus of the present invention.

FIG. 9 is an interior view of the perforated sheet as used within the interior of the heating pipe of the frying apparatus of the present invention.

### DETAILED DESCRIPTION OF THE INVENTION

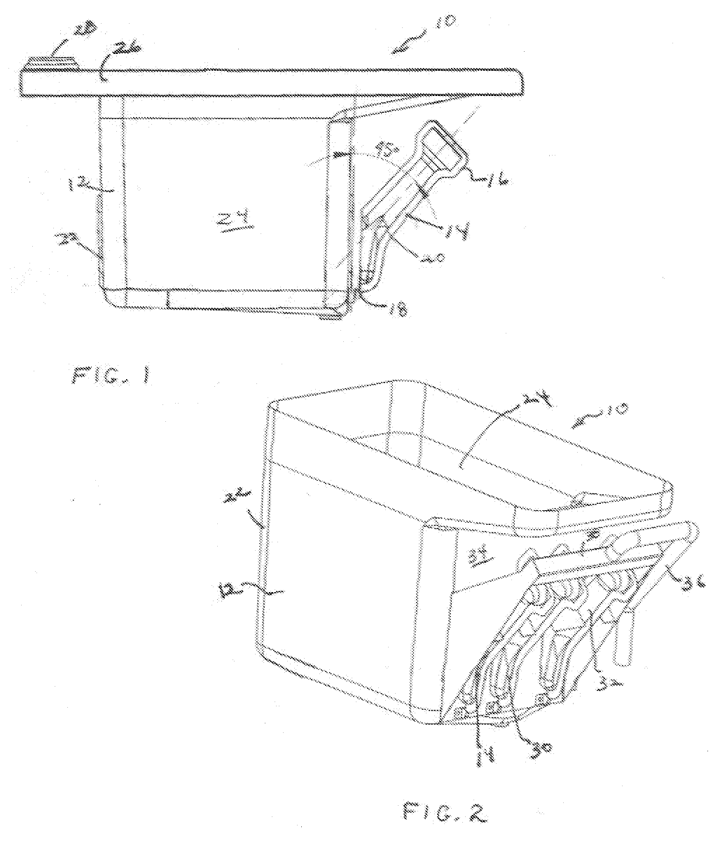

Referring to FIG. 1, there is shown the frying apparatus 10 in accordance with the teachings of the present invention. The frying apparatus 10 includes a reservoir 12 and a burner 14. As can be seen, the burner 14 has a connector end 16. The opposite end of the burner 14 will be connected to a pipe 18 extending through the interior of the reservoir 12. The burner 14 includes a venturi passageway 20 formed on an interior passageway of the burner 14. The burner 14 serves to pass a heated gas to the a plurality of pipes 18 located within the interior of the reservoir 12. The burner 14 is illustrated as extending at a 45 degree angle with respect to a vertical axis of the reservoir 12.

The reservoir 12 includes a monolithic body 22 having a cooking pool 24 formed on an interior thereof. An upper table 26 is affixed to the monolithic body 22. In particular, the upper table 26 can be in a welded position on the top of the monolithic body 22. The plurality of pipes 18 will extend in heat exchange relationship within the cooking pool 24 of the reservoir 12. A chimney 28 is illustrated as extending above the top surface of the upper table 26. Chimney 28 allows the heated gases passing through the plurality of pipes 18 to pass outwardly of the apparatus 10.

FIG. 2 illustrates the frying apparatus 10 of the present invention without the upper table 26 attached thereto. As can be seen, the monolithic body 22 of reservoir 12 has the cooking pool 24 formed on an interior thereof. A plurality of burners 14, 30 and 32 each extend at 45 degree angle with respect to the vertical wall 34 of the reservoir 12. A tube 36 is connected to a manifold 38 for the delivery of the gas into each of the burners 14, 30 and 32.

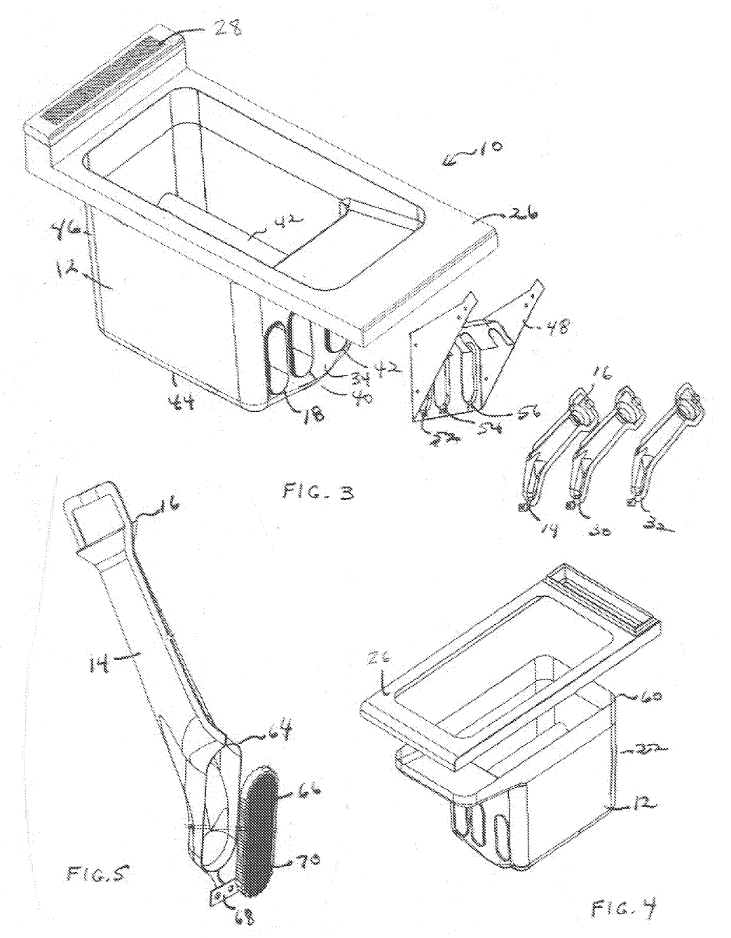

FIG. 3 shows an exploded view of the frying apparatus 10 of the present invention. As can be seen, the reservoir 12 has the upper table 26 affixed to a top surface thereof. Chimney 28 extends outwardly from the top of the upper table 26. A plurality of pipes 18, 40 and 42 are illustrated as extending across the bottom 44 of the reservoir 12. Each of the pipes 18, 40 and 42 is welded to opposite walls 34 and 46 of the reservoir 12. It can be seen that each of the pipes 18, 40 and 42 has an elliptical shape such that a wide surface of the plurality of pipes 18, 40 and 42 extends generally vertically. A bracket 48 is configured so as to be affixed to the wall 34 of the reservoir 12 and has openings 52, 54 and 56 generally aligned with the pipes 18,40 and 42, respectively. Burners 14, 30 and 32 are configured so as to be affixed to the bracket 48 such that the lower end thereof opposite the connecter 16 is secured within the holes 52, 54 and 56.

FIG. 4 illustrates that the reservoir 12 has the monolithic body 22 having an upper edge 60. The upper table 26 is welded to the upper edge 60 so as to be fixed into position.

FIG. 5 is an isolated view of the burner 14. Burner 14 has a connecter end 16 at one end. A horizontal section 64 is formed at the opposite end of the burner 14. A sheet block 66 is affixed over the end of the opening of the horizontal section 64 and over the outlet of the burner 14. A small bracket 68 is formed at the bottom of the horizontal section 64 so as to allow the burner 14 to be securely affixed to the bracket 68. The sheet block 66 will be interposed between the burner 14 and the pipe 18. The sheet block 66 has a serrated surface 70 formed thereacross.

FIG. 6 is a detailed view of the serrated surface 70 of the sheet block 66. The serrated surface 70 includes a sequence of chord lines extending across the inner diameter of the sheet block 66. Corrugated lines will extend between each of the chord lines so as to form the serrated surface.

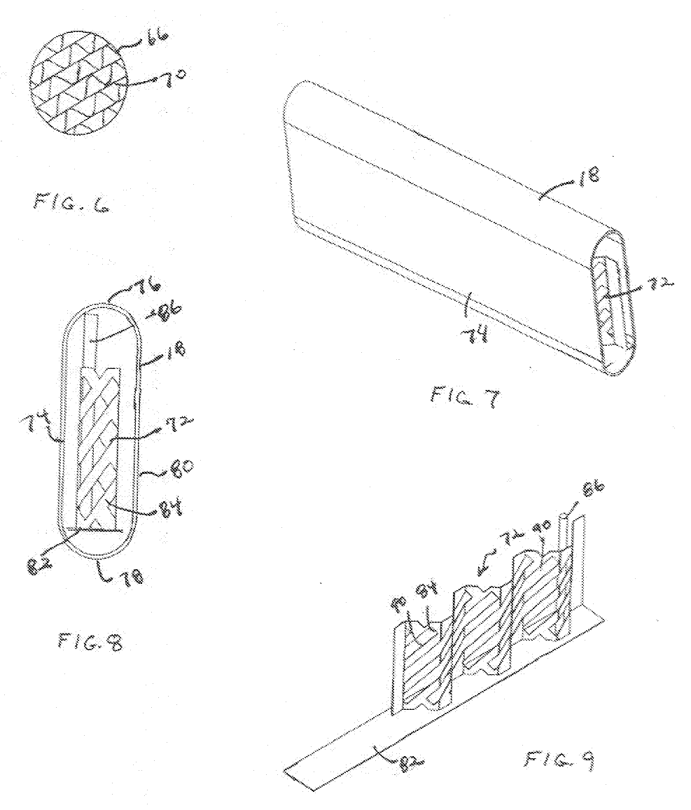

FIG. 7 is an isolated view of t he heat pipe 18. The heating pipe 18 includes a flame directing means 72 formed on an interior thereof. The pipe 18 has a wide surface 74 formed on a side thereof. As such, the side 74 provides a wide surface area for the heat exchange relationship between the pipe 18 and the cooking fluid within the interior of the reservoir 12. The flame directing means 72 serves to direct the heated gas in a desired pattern through the pipe 18.

FIG. 8 shows how the flame directing means 72 is positioned on the interior of pipe 18. Pipe 18 has a semicircular curved top 76 and a semicircular bottom 78 with straight side walls 74 and 80 extending therebetween. The flame directing means 72 is positioned on a platform 82 thrusting adjacent to the bottom 78. A perforated sheet 84 is supported on the platform 82 and extends upwardly therefrom and is support by a rod 86. Rod 86 extends vertically within the pipe 18.

FIG. 9 is a detailed view of the flame directing means 72 as used within the pipe 18. As can be seen the platform 82 is a flat sheet with the perforated sheet 84 supported thereon. Perforated sheet 84 has rectangular-shaped perforations 90 formed therein. The perforated sheet 84 has a convoluted pattern throughout the interior of the pipe 18. Rod 86 supports the perforated sheet 84 at one end of the platform 82.

In the present invention, the fryer 10 is designed so as to shorten the cooking time for large volumes of ingredients that are to be cooked in industrial kitchens. The cooking time can include the actual cooking time, the reheating time, the normal cooking time and the re-cooking time. The present invention serves to transfer a large amount of heat to a cooking pool in a short period of time. This is accomplished by the pipes that are designed with special geometry so as to cooperate with burners. Flame directing devices are placed in the pipe for facilitating the transfer of heat. The monolithic body of the reservoir is a hygienic monoblock such that the reservoir can be easily cleaned and such that waste foods are free of any bacteria.

The burners 18, 30 and 32 are mounted on an angle of 45 degree with respect to the vertical axis of the cooking reservoir 12 via sheet block 66. The sheet block 66 has a serrated surface 70 such that this special geometry facilitates the burning processes. The burning processes take place in the internal portion of the burner 14 and at the sheet block 66. Because of the mounting angle of 45 degree and the serrated surface 70 of the sheet block 66, it is ensured that particular LPG gases (which are heavier than air in mass) are burned with high power and with minimal noise and back pressure. These gases can include propane, butane and a mixture of propane and butane.

If the burners 14 were mounted of any other mounting angle other than 45 degree, the flame would hit the upper or lower surfaces at the inlet of the flame heating pipe 18 such that the burning quality and efficiency decreases.

The heating pipes 18, 40 and 42 are designed with an elliptical shape in accordance with the geometry of the burners 14 in order to increase the heat transfer surface. Efficiency is improved by lengthening the path taken by the flame by means 72 of the flame directing means located within the heating pipes 18, 40 and 42. The gas that bums at high temperatures proceeds within the pipe 18, 40 and 42 by hitting the upper and lower parts thereof with no back pressure. This is created by the convoluted geometry of the perforated sheet 84 along with the rectangular channels of the perforated sheet 84. Therefore, the temperature of the flue gas of the flame in the heating pipe 18, 40 and 42 is decreased and the efficiency is increased. The flame in the heating pipes 18, 40 and 42 is discharged via the chimney 28.

The monolithic body 22 is formed by a deep extraction method. It is then welded to the upper table 26 by way of seam welding. The pasta fire can be pressed deeper because of a loss of volume due to the heating pipes 18, 40 and 42. The heating pipes 18, 40 and 42 are welded to the monolithic body 22. All corners of the cooking pool 24 are designed with a radius so as to prevent accumulation of waste food and for easy cleaning.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A frying apparatus comprising:
a reservoir;
a plurality of pipes in heat exchange relationship with said reservoir; and
a burner means connected to said plurality of pipes, said burner means for passing a heated gas to said plurality of pipes, said burner means comprising a venturi passageway extending at a 45° angle with respect to a vertical axis of said reservoir.

2. The frying apparatus of claim 1, further comprising:
a sheet block interposed between said burner means and at least one of said plurality of pipes, said sheet block having a serrated surface extending thereacross.

3. The frying apparatus of claim 2, said venturi passageway having a connector end at one end thereof, said sheet block affixed over an opposite end of said venturi passageway.

4. The frying apparatus of claim 3, said opposite end of said venturi passageway having a horizontal section, said sheet block fitted over said horizontal section.

5. The frying apparatus of claim 1, said burner means comprising a plurality of venturi passageways each connected respectively to said plurality of pipes.

6. The frying apparatus of claim 1, said plurality of pipes extending across an interior of said reservoir, said plurality of pipes being in sealed relationship with opposite walls of said reservoir.

7. The frying apparatus of claim 1, each of said plurality of pipes having an elliptical shape such that a wide surface of said plurality of pipes extends generally vertically.

8. The frying apparatus of claim 1, further comprising:
a flame directing means positioned interior of said plurality of pipes, said flame directing means for directing the heated gas in a desired pattern through said plurality of pipes.

9. The frying apparatus of claim 8, said flame directing means comprising a perforated sheet extending through said interior of each of said plurality of pipes.

10. The frying apparatus of claim 9, said perforated sheet having a convoluted shape.

11. The frying apparatus of claim 9, said perforated sheet having rectangular channels formed therein.

12. The frying apparatus of claim 1, further comprising:
a chimney affixed to an opposite end of said plurality of pipes from said burner means.

13. The frying apparatus of claim 12, said chimney opening at a top of said reservoir so as to direct the heated gas vertically outwardly from said plurality of pipes.

14. The frying apparatus of claim 1, said reservoir comprising:
a monolithic body having a cooking pool formed on the interior thereof; and
an upper table affixed to a top of said monolithic body.

15. A frying apparatus comprising:
a reservoir;
a plurality of pipes in heat exchange relationship with said reservoir;
a burner means connected to said plurality of pipes, said burner means for passing a heated gas to said plurality of pipes; and
a flame directing means positioned interior of said plurality of pipes, said flame directing means for directing the heated gas in a desired pattern through said plurality of pipes.

16. The frying apparatus of claim 15, said burner means comprising a venturi passageway connected to said plurality of pipes and extending at a 45° angle with respect to a vertical axis of said reservoir.

17. The frying apparatus of claim 15, said flame directing means comprising a perforated sheet extending through said interior of each of said plurality of pipes, said perforated sheet having a convoluted shape, said perforated sheet having rectangular channels formed therein.

18. The frying apparatus of claim 15, further comprising:
a sheet block interposed between said burner means and at least one of said plurality of pipes, said sheet block having a serrated surface extending thereacross.

19. The frying apparatus of claim 18, said venturi passageway having a connector end at one end thereof, said sheet block affixed over an opposite end of said venturi passageway, said opposite end of said venturi passageway having horizontal section, said sheet block fitted over said horizontal section.

20. The frying apparatus of claim 15, said reservoir comprising:
a monolithic body having a cooking pool formed on the interior thereof; and
an upper table affixed to a top of said monolithic body.
